(19) United States
(12) Patent Application Publication
(10) Pub. No.: US 2021/0380318 A1
(43) Pub. Date: Dec. 9, 2021

(54) PACKAGING ARTICLES COMPRISING ANTIMICROBIAL AND/OR ANTIVIRAL COATING, AND METHODS AND SYSTEMS FOR FORMING SAME

(71) Applicant: SINOMAX USA, INC., Houston, TX (US)

(72) Inventor: John Beliveau, Nashville, TN (US)

(73) Assignee: SINOMAX USA INC., Houston, TX (US)

(21) Appl. No.: 17/339,769

(22) Filed: Jun. 4, 2021

Related U.S. Application Data
(60) Provisional application No. 63/035,588, filed on Jun. 5, 2020.

(51) Int. Cl. B65D 65/42; B05D 3/02; B05D 1/28; B65D 85/07; C09D 1/00; C09D 5/14; C09D 179/00

(52) U.S. Cl. CPC B65D 65/42; B05D 3/0254; B05D 1/28; C09D 179/00; C09D 1/00; C09D 5/14; B65D 85/07

(57) ABSTRACT

I disclose a composition, comprising a solvent; and a compound selected from antimicrobial compounds or antiviral compounds. I also disclose packaging articles comprising a base article having an outer surface and an inner surface; and a coating on at least a portion of the outer surface of the base article, wherein the coating comprises a compound selected from antimicrobial compounds or antiviral compounds. I also disclose methods of forming the composition and forming the packaging article and systems for forming the packaging article.

### BACKGROUND OF THE INVENTION

### Field of the Invention

Generally, the present disclosure relates to packaging, and, more specifically, to packaging comprising an antimicrobial and/or antiviral coating.

### Description of the Related Art

Biohazards, such bacteria, virus, etc., attaching themselves on materials are of concern. The coronavirus pandemic of 2019-2021 emphasizes the need for people to avoid infectious agents in their environment. Unfortunately, the interdependent and globalized nature of economic life in the early 21^{st} century brings consumers and supply-chain workers into contact with large numbers of packaged goods. Much uncertainty exists regarding the survivability of infectious agents, such as viruses, bacteria, molds, and/or mildews, on common packaging materials. Numerous people, already troubled by threats to their health and disruptions in their careers and daily lives, felt forced by the coronavirus pandemic to spend hours after each trip to a grocery store or other merchant disinfecting the packages they have purchased. Current efforts to address infectious agents on materials such as packaging can be inefficient and/or not fully effective.

Accordingly, it would be desirable to reduce the survivability of infectious agents on packaging for goods in the flow of commerce.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to a composition, comprising a solvent; and a compound selected from antimicrobial compounds or antiviral compounds.

In one embodiment, the present disclosure is directed to a packaging article, comprising a base article having an outer surface and an inner surface; and a coating on at least a portion of the outer surface of the base article, wherein the coating comprises a compound selected from antimicrobial compounds or antiviral compounds.

In one embodiment, the present disclosure is directed to a method, comprising providing a base article having an outer surface and an inner surface; applying to at least a portion of the outer surface of the base article a composition comprising a solvent and a compound selected from antimicrobial compounds or antiviral compounds; and removing the solvent to yield a coating on at least a portion of the outer surface of the base article, wherein the coating comprises the compound selected from antimicrobial compounds or antiviral compounds.

In one embodiment, the present disclosure is directed to a method, comprising mixing a solvent and a compound selected from antimicrobial compounds or antiviral compounds under conditions sufficient to yield a composition in the form of a solution or slurry.

The present disclosure may provide for packaging articles with reduced survivability of infectious agents on packaging for goods purchased by a consumer and/or handled by one or more supply-chain workers.

### BRIEF DESCRIPTION OF THE DRAWINGS

The disclosure may be understood by reference to the following description taken in conjunction with the accompanying drawings, in which like reference numerals identify like elements, and in which:

FIG. 1 schematically depicts a base article, in accordance with embodiments herein.

FIG. 2 schematically depicts a portion of a base article with a coating on at least a portion of an outer surface thereof, in accordance with embodiments herein.

FIG. 3A conceptually depicts a base article during a first stage of processing, in accordance with embodiments herein.

FIG. 3B conceptually depicts a base article during a second stage of processing, in accordance with embodiments herein.

FIG. 3C conceptually depicts a base article during a third stage of processing, in accordance with embodiments herein.

FIG. 3D conceptually depicts a base article during a fourth stage of processing, in accordance with embodiments herein.

FIG. 3E conceptually depicts a base article during a fifth stage of processing, in accordance with embodiments herein.

FIG. 3F conceptually depicts a base article after the fifth stage of processing, in accordance with embodiments herein.

FIG. 4 is a flowchart of a first method, in accordance with embodiments herein.

FIG. 5 is a flowchart of a second method, in accordance with embodiments herein.

FIG. 6 is a schematic representation of a system, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein are directed to compositions comprising a compound selected from antimicrobial compounds or antiviral compounds; to packaging materials comprising a base article having an outer surface and an inner surface, wherein the composition is present on at least a portion of the outer surface; methods of forming the composition; and methods of coating the base article with the composition. Embodiments herein are also directed to various methods for implementing antimicrobial compounds or antiviral compounds onto packages.

In one embodiment, the present disclosure relates to a composition, comprising a solvent and a compound selected from antimicrobial compounds or antiviral compounds.

The solvent may be any substance in which the compound selected from antimicrobial compounds or antiviral compounds may be dissolved or slurried. Exemplary solvents may be those used in inks, varnishes, ultraviolet (UV) coatings, aqueous coatings, and liquid laminate coatings, as known to the person of ordinary skill in the art.

A varnish is essentially ink-type material without pigment. It may require its own printing unit on press. It can be wet-trapped (printed in-line at the same time other inks are laid down), or dry-trapped (run as an additional pass through the press after the initial ink coating has dried). The latter often provides a glossier finish. Varnish comes in gloss, dull, and satin (in-between dull and gloss), and can be tinted by adding pigment to the varnish.

A UV coating is generally a substantially clear liquid spread over the paper like ink and then cured substantially instantly with ultraviolet light. It can be a gloss or dull coating and can be used as a spot covering to accent a particular image on the sheet or as an overall (flood) coating. UV coating generally gives more protection and sheen than either varnish or aqueous coating. Since it is cured with light and not heat, generally, no solvents enter the atmosphere. However, it is more difficult to recycle than the other coatings.

UV coating can be applied as a separate finishing operation as a flood coating, spray coating, or (applied by screen printing) as a spot coating.

An aqueous coating is water based. It has better hold-out than varnish (it generally does not seep into the press sheet) and generally does not crack or scuff easily.

Because at this writing it is typically applied by an aqueous coating tower at the delivery end of the press, it is typically laid down as a flood aqueous coating, not a localized “spot” aqueous coating. Aqueous comes in gloss, dull, and satin.

A liquid laminate can have a gloss or matte finish. A clear liquid is spread over the sheet and dries (or cures) like a varnish. Laminates protect the sheet from water (including perspiration from the hands) and are therefore good for coating items like menus and book covers. Laminates are slow to apply and costly but provide a strong, washable surface.

In one embodiment, the solvent may be water. In another embodiment, the solvent may be an ultraviolet-curable (UV-curable) material. A particular solvent may be selected as a routine matter by the person of ordinary skill in the art having the benefit of the present disclosure.

Although the word “solvent” in common parlance refers to a material that is a liquid at room temperature and ambient pressure, the solvent of the composition need not be a liquid at room temperature and ambient pressure.

The composition of this embodiment additionally comprises a compound selected from antimicrobial compounds or antiviral compounds. By “antimicrobial” is meant that the compound is fatal to and/or inhibits the growth and/or reproduction of at least one bacterium, mold, and/or mildew. By “antiviral” is meant that the compound destroys at least one virus or inhibits the infectiveness thereof. The person of ordinary skill in the art will understand that a compound selected from antimicrobial compounds or antiviral compounds performs the relevant function by having structural features that are harmful or fatal to one or more microorganisms or destroy or inhibit one or more viruses. Exemplary antimicrobial and/or antiviral compounds include, but are not limited to, silver ion compounds; zinc compounds; copper compounds; quaternary ammonium compounds (“quats”), for example, N-alkyl dimethyl benzyl ammonium chloride, N-octyl decyl dimethyl ammonium chloride, di-n-decyl dimethyl ammonium chloride, and di-n-octyl dimethyl ammonium chloride; oxazoline homopolymers, e.g., poly(2-ethyl-2-oxazoline); oxazoline copolymers, such as with a heterocyclic comonomer; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles, e.g. propiconazole; polyhexamethylene biguanide hydrochloride; 3,4,4′-trichlorocarbanilide; isothiazolone-based compounds, such as 1,2-benzisothiazolin-3-one, N-butyl-1,2-benzisothiazolin-3-one, 2-octyl-isothiazolone, 4,5-dichloro-2-N-octyl-3 (2H)-isothiazolone, methyl-3 (2H)-isothiazolone, or chloro-2-methyl-3 (2H)-isothiazolone; alkyl dimethyl ammonium saccharinate; oxathiazines; or chlorothalonil. Numerous antimicrobial and/or antiviral technologies are commercially available from Microban International, Ltd., Huntersville, N.C.

The composition of this embodiment may comprise two or more antimicrobial compounds, two or more antiviral compounds, and/or one or more antimicrobial compounds and one or more antiviral compounds. In one embodiment, the composition may comprise from 0.2 to 3 parts by weight of an oxazoline homopolymer and from 0.05 to 20 parts by weight of a quat.

In one embodiment, the composition may further comprise a pigment. A “pigment” as used herein is any compound that imparts a color to a mixture containing the compound. The person of ordinary skill in the art will understand that a pigment performs this function by having structural features that allow it to absorb and/or reflect light at one or more visual wavelengths, i.e., compositions that can display various colors.

In other embodiments, the composition may further comprise one or more other materials known to the person of ordinary skill in the art for use in the printing or coating of packaging articles.

The solvent, the compound selected from antimicrobial compounds or antiviral compounds, and any other materials that may be present may be present in any desired proportions that will be found as a routine matter by the person of ordinary skill in the art having the benefit of the present disclosure.

In another embodiment, the present disclosure relates to a packaging article, comprising a base article having an outer surface and an inner surface; and a coating on at least a portion of the outer surface of the base article, wherein the coating comprises a compound selected from antimicrobial compounds or antiviral compounds.

The base article may be any three-dimensional article configured to contain a product in any portion or the entirety of a chain of commerce from a factory or other facility in which the product is made to a store or a delivery location at which the product comes into possession of an end user. The base article may be of any shape, such as a rectangular prism, a sphere, a triangular prism, or the like. In one embodiment, the base article may have a complex shape, e.g., it may have a rectangular prism shape as seen from the outside, but upon opening, the interior of the base article may comprise one or more spacer or packer elements, such as foamed styrene, rigid cardboard, or the like.

The base article may be continuous, i.e., it may completely surround the product, or it may be discontinuous, i.e., it may incompletely surround the product. Examples of discontinuous base articles and products they may be configured to contain include packaging for interactive toys, which may have a “try me” opening for a consumer to reach into the base article and test at least one of the toy's interactive element, and packaging for basketballs, which may be a rectangular prism configured to surround the ball's equator.

Regardless of the shape and whether continuous or discontinuous, the base article has an outer surface and an inner surface. The outer surface comprises all faces and edges configured for exposure to a consumer, a stocker, a shipping employee, a factory employee. The inner surface comprises all faces and edges in contact with the packaged product.

The base article may be made of any material suitable for use in a packaging article for any particular consumer product. In one embodiment, the base article may comprise cardboard. Alternatively, or in addition, the base article may comprise paper. Alternatively, or in addition, the base article may comprise paperboard. Alternatively, or in addition, the base article may comprise metal. Alternatively, or in addition, the base article may comprise viscoelastic foam. Alternatively, or in addition, the base article may comprise flexible plastic. Alternatively, or in addition, the base article may comprise rigid plastic, such as, but not limited to, foamed styrene, among others.

In one embodiment, the base article comprises cardboard, paper, paperboard, metal, viscoelastic foam, flexible plastic, rigid plastic, or two or more thereof.

The product which the base article is configured to retain may be chosen from any known consumer products. Examples of such products include, but are not limited to, foodstuffs for people and animals, beverages, clothing, appliances, consumer electronics, toys, games, sporting goods, books, furniture, household supplies, office supplies, tools, auto supplies, and mailing/shipping boxes, among many others. In one embodiment, the base article is configured to retain a mattress, a mattress topper, or a pillow.

FIG. 1 schematically depicts a base article 110, in accordance with embodiments herein. For convenience, the base article 110 is depicted as a two-dimensional article. The person of ordinary skill in the art having the benefit of the present disclosure will readily envision a three-dimensional article from the depicted base article 110.

The base article 110 comprises an outer surface 111, comprising four faces 111a, 111b, 111c, and 111d, and an inner surface 112, comprising four faces 112a, 112b, 112c, and 112d. As depicted, face 111a is opposite to face 112a. However, as mentioned above, the inner surface 112 need not comprise faces in one-to-one correspondence to faces of the outer surface 111.

The inner surface 112 circumscribes an interior 113 of the base article 110. The interior 113 may accordingly retain a product desired for packaging.

The packaging article 100 of the present embodiment also comprises a coating on at least a portion of the outer surface of the base article, wherein the coating comprises a compound selected from antimicrobial compounds or antiviral compounds. Generally, the compound selected from antimicrobial compounds or antiviral compound, may be as described above regarding the composition. The relative proportions of the compound selected from antimicrobial compounds or antiviral compounds and any other compounds that may be present will generally be the same or similar to their relative proportions as described above regarding the composition.

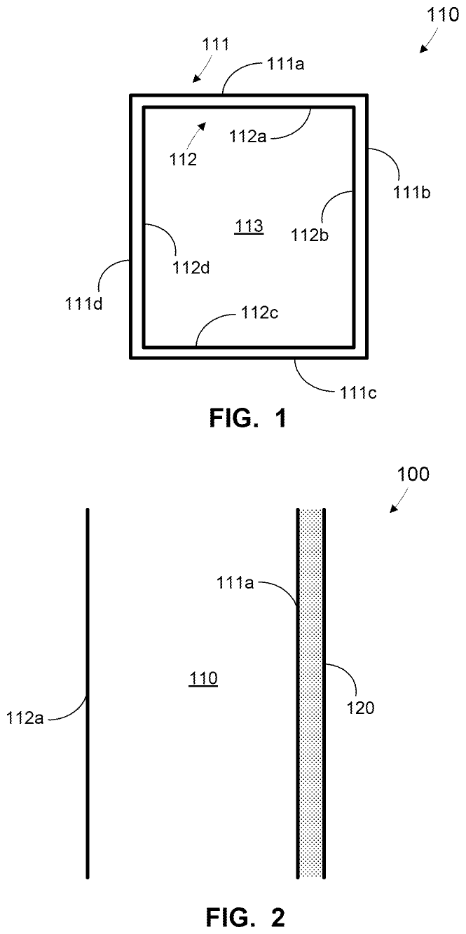

FIG. 2 schematically depicts a portion of a packaging article 100, comprising the base article 110 with a coating 120 on at least a portion of the outer surface 111 thereof, in accordance with embodiments herein. The coating 120 may be of any desired thickness. For the avoidance of doubt, the wall of the base article 110 and the coating 120 are not to scale.

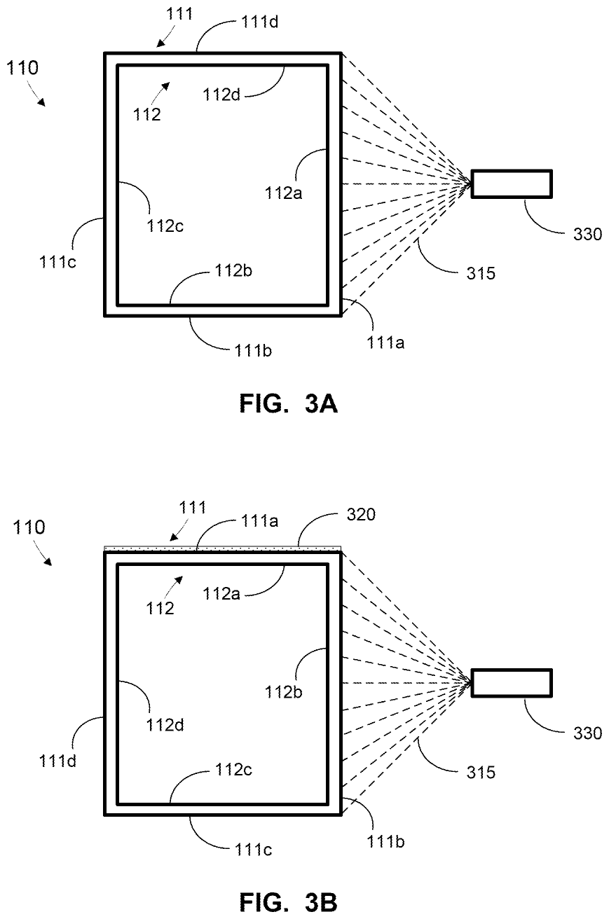

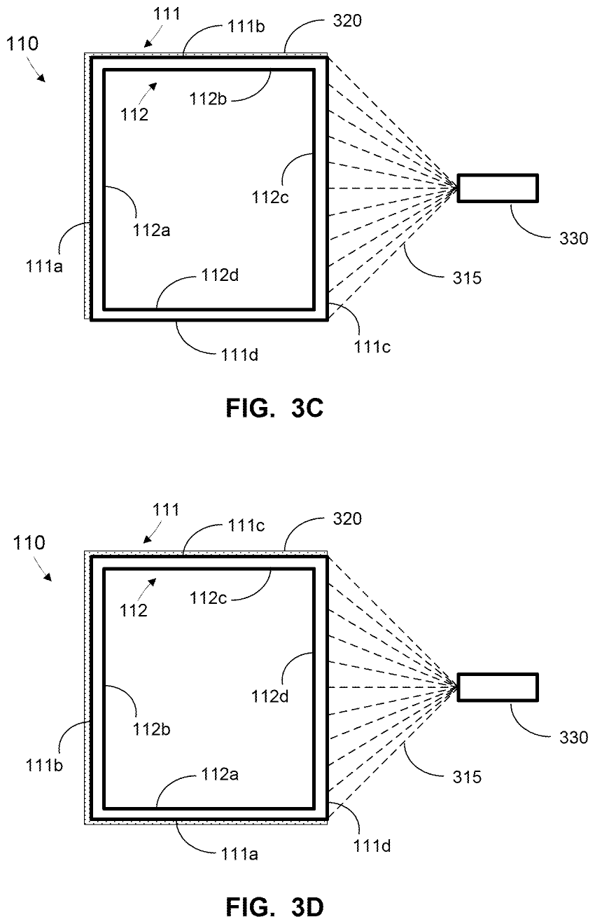

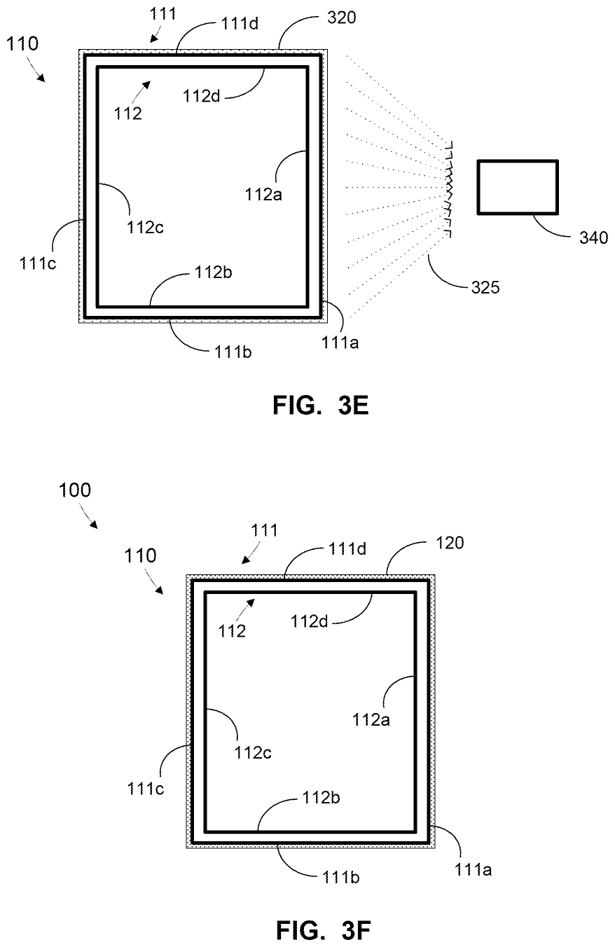

Turning to FIG. 3A, the base article 110 during a first stage of processing, in accordance with embodiments herein, is depicted conceptually. In FIG. 3A, the base article 110 is brought into proximity to a sprayer 330. The base article 110 is oriented such that face 111a of the outer surface 111 is exposed to the sprayer 330. The sprayer 330 is configured to spray a composition 315 substantially uniformly over the entirety of the face 111a. The composition 315 is generally identical to the composition described above, comprising a solvent and a compound selected from antimicrobial compounds or antiviral compounds.

Although FIG. 3A-3D show the composition 315 is applied to the faces 111a-111d of the outer surface 111 by a sprayer 330, in other embodiments (not shown), the composition 315 may be applied to the faces 111a-111d by other techniques, such as printing, brushing, rolling, or dipping, among others the person of ordinary skill in the art having the benefit of the present disclosure may implement as a routine matter.

FIG. 3B conceptually depicts the base article 110 during a second stage of processing, in accordance with embodiments herein. After spraying the composition 315 onto the face 111a (FIG. 3A) to yield wet coating 320, the base article 110 is rotated to expose face 111b to the sprayer 330. The composition 315 is then sprayed onto face 111b of the outer surface 111, as described above regarding FIG. 3A

FIG. 3C conceptually depicts the base article 110 during a third stage of processing, in accordance with embodiments herein. A rotation was performed to expose face 111c to the sprayer 330 and the composition is then sprayed onto face 111c.

FIG. 3D conceptually depicts the base article 110 during a fourth stage of processing, in accordance with embodiments herein. An additional rotation and spraying of the composition 315 onto face 111d are performed as described above.

FIG. 3E conceptually depicts the base article 1109 during a fifth stage of processing, in accordance with embodiments herein. In this stage, the wet composition 320 is present on all faces 111a-111d of the outer surface 111. In the fifth stage of processing, the base article 110 is brought into proximity to a dryer 340 and the solvent is thereby extracted 325 from the wet coating 320. The extraction 325 may be conceptual, i.e., the solvent may undergo a chemical transformation from a liquid form to a cured form.

The dryer 340 may be an active dryer, such as an appliance that generates heat, moves air, dehumidifies air, shines UV light, and/or applies reduced pressure to the wet coating 320, or it may be a passive dryer, such as a room or other location configured to allow the solvent to evaporate.

FIG. 3F conceptually depicts the base article 110 after the fifth stage of processing, in accordance with embodiments herein. The fifth stage of processing yields the packaging article 100, comprising the base article 110 and the coating 120 on at least a portion of the outer surface 111.

Although FIGS. 3A-3F show the coating 120 present over substantially the entire outer surface 111 of the base article 110, in other embodiments, the coating 120 may be present over only a portion of the outer surface 111. For the sake of consumer safety and acceptance, in this latter embodiment, the coating 120 may be combined with a pigment or combination of pigments showing zones where consumers are recommended to pick up the packaging article 100. For example, two zones each with a handprint and/or the words “Pick up here” or the like may be included on opposite faces of the outer surface 111, e.g. on faces 111a and 111d in FIG. 3F.

Also, although FIGS. 3A-3F show the coating 120 present over substantially the entire outer surface 111 of the base article 110, in other embodiments, the coating 120 may also be present over a portion of or substantially the entirety of the inner surface 112. This may be desirable for products which require the consumer to reach into and/or disassemble the base article 110 or portions thereof to remove the entirety of the product for assembly and/or use.

Additionally, although FIGS. 3A-3F conceptually depict the composition 315 being applied to a base article 110 after the base article 110 has been given its final configuration, in practice, the application of the composition 315 and the removal of the solvent 325 may be performed when the base article 110 is in an unfolded, flat-packed, or partially assembled conformation.

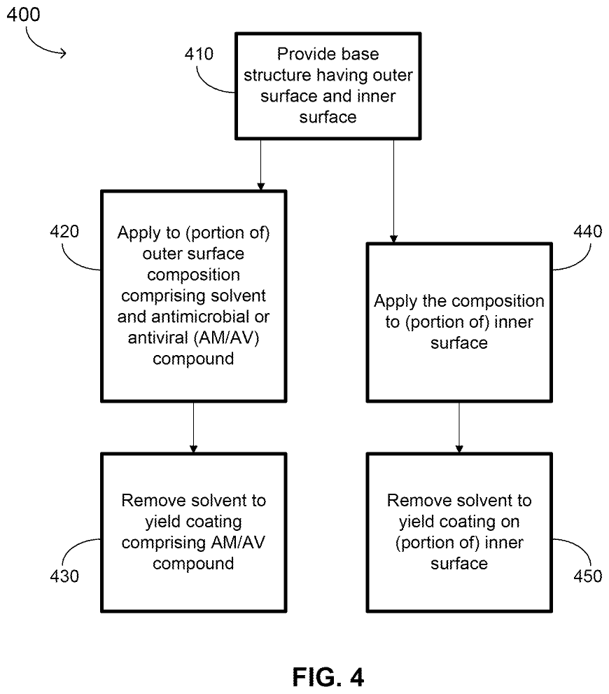

FIG. 4 is a flowchart of a first method 400, in accordance with embodiments herein. The method 400 comprises providing (at 410) a base article having an outer surface and an inner surface. In one embodiment, the base article comprises cardboard, paper, paperboard, metal, viscoelastic foam, flexible plastic, rigid plastic, or two or more thereof. Alternatively, or in addition, the base article is configured to retain a mattress, a mattress topper, or a pillow. In some embodiments, the base article may be a cardboard box, a packaging for shipping a mattress, a container made of plastic, a container made of resin, a cereal box, etc.

The method 400 also comprises applying (at 420), to at least a portion of the outer surface of the base article, a composition comprising a solvent; and a compound selected from antimicrobial compounds or antiviral compounds.

In one embodiment, the applying (at 420) comprises spraying the composition onto the outer surface. In one embodiment, the applying (at 420) comprises printing, brushing, or rolling the composition onto the outer surface. In one embodiment, the applying (at 420) comprises contacting the outer surface of the base article with a reservoir of the composition, i.e., dipping the base article into the composition.

Various techniques for applying (at 420) will be known to the person of ordinary skill in the art having the benefit of the present disclosure. These techniques may be chosen based on various parameters. For example, dried inks show fingerprints and scuffing, especially in dark solids. Press coatings (like varnish) cost less than bindery (off-press) coatings (like UV coating and laminates) since bindery coatings are applied over dry ink at slow speeds. Because the chemicals used in aqueous coating damage press rollers, this coating is more expensive for the printer/binder to apply than varnish. Varnish is the least effective way to prevent scuffing, particularly when publications are multiply shrink-wrapped (as opposed to singly shrink-wrapped) prior to shipping. Bindery coatings like UV coating and laminates are far better for protecting loose books in transit. Even aqueous coating is much stronger than varnish and can therefore withstand books shifting around in transit without scuffing. All printers can apply varnish, but not all printers can apply laminates, UV coating, or aqueous coating. The person of ordinary skill in the art cannot print (ink-jet or by hand), glue, or foil stamp over coatings, and hence must leave an uncoated window if he or she desires to do any of these. In other words, coatings should be the final finishing step on a printed piece. Varnish is best applied only to coated stock, or the coating will seep into the paper and be lost. Finally, some coatings deepen the ink color they cover, yellow with age, and/or discolor white paper.

The method 400 also comprises removing (at 430) the solvent to yield a coating on at least a portion of the outer surface of the base article, wherein the coating comprises the compound selected from antimicrobial compounds or antiviral compounds.

In one embodiment, the removing (at 430) comprises applying heat, reduced pressure, reduced humidity, UV light, or two or more thereof to the composition on the outer surface. In one embodiment, the removing (at 430) comprises maintaining ambient temperature, humidity, and pressure in proximity to the composition on the outer surface.

In one embodiment, the method 400 further comprises applying (at 440) the composition to at least a portion of the inner surface of the base article; and removing (at 450) the solvent to yield a coating on at least a portion of the inner surface of the base article. The applying (at 440) and the removing (at 450) may be performed using techniques as described for particular embodiments of applying (at 420) and removing (at 430).

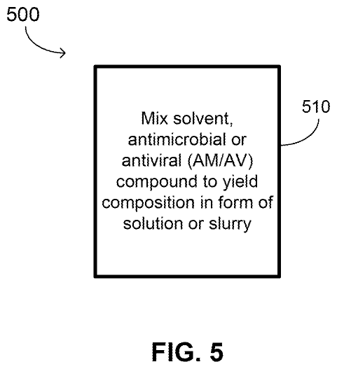

FIG. 5 is a flowchart of a second method 500, in accordance with embodiments herein. The method 500 comprises mixing (at 510) a solvent and a compound selected from antimicrobial compounds or antiviral compounds under conditions sufficient to yield a composition in the form of a solution or slurry.

In one embodiment, the composition is a liquid at room temperature and ambient pressure. In one embodiment, the solvent is water. In one embodiment, the solvent is a UV-curable material. Alternatively, or in addition, the mixing (at 510) may further comprise mixing a pigment and/or other materials with the solvent and the compound selected from antimicrobial compounds or antiviral compounds.

In one embodiment, the mixing (at 510) may comprise providing the compound selected from antimicrobial compounds or antiviral compounds as a liquid or powder; and combining the liquid or powder with an ink. This embodiment may be suitable for printing at least a portion of the outer surface of a box.

In one embodiment, the mixing (at 510) may comprise providing the compound selected from antimicrobial compounds or antiviral compounds as a liquid and combining the liquid with a solvent comprising a UV-curable material. This embodiment may be suitable for forming a UV coating that goes on as a clear “seal” over an entire printed or unprinted box. This embodiment may allow the packaging article to have essentially all of its outer surface comprise an antimicrobial or antiviral coating.

However formed, the composition generated by the method 500 may be provided to the applying (at 420) or applying (at 440) of the first method 400.

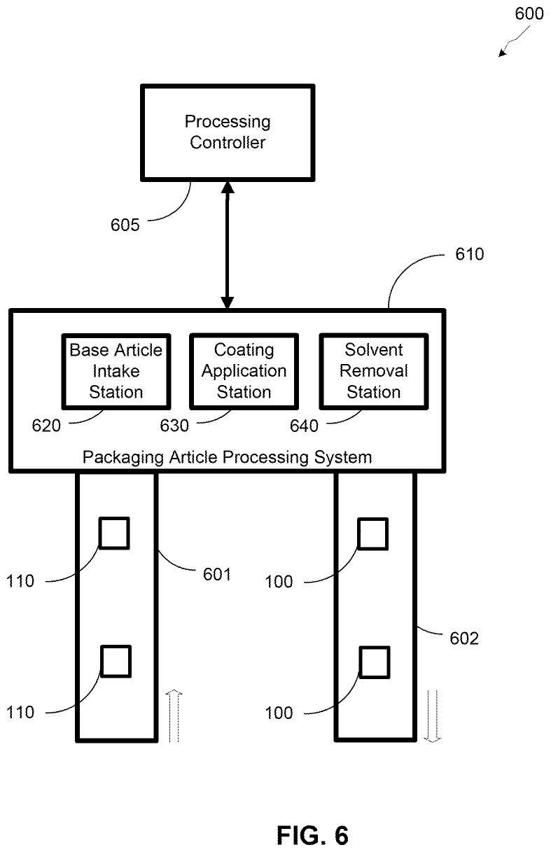

Turning now to FIG. 6, a stylized depiction of a system 600 for fabricating a packaging article comprising an antimicrobial and/or antiviral coating, in accordance with embodiments herein, is illustrated. A system 600 of FIG. 6 may comprise a packaging article processing system 610. The packaging article processing system 610 may comprise various processing stations, such as a base article intake station 620, a coating application station 630, a solvent removal station 640, etc. Data may be gathered from any of the foregoing stations or any other component of the packaging article processing system 610, and may be used to modify one or more process parameters used by the various stations or any other component for performing process steps.

The system 600 may also comprise a processing controller 605. One or more of the processing steps performed by the packaging article processing system 610 may be controlled by the processing controller 605. The processing controller 605 may be a workstation computer, a desktop computer, a laptop computer, a tablet computer, or any other type of computing device comprising one or more software products that are capable of controlling processes, receiving process feedback, receiving test results data, performing learning cycle adjustments, performing process adjustments, etc.

In the particular embodiment depicted schematically in FIG. 6, the packaging article processing system 610 may receive one or more base articles 110 at a base article intake station 620. For example, the base articles 110 may be provided via a first conveyor belt 601 or comparable conveyance apparatus. The base articles 110 each have an outer surface and an inner surface, bearing in mind that “outer” and “inner” refer to the article's final conformation, when it is ready to receive a packaged good.

The packaging article processing system 610 may apply to at least a portion of the outer surface of the base article a composition comprising a solvent; and a compound selected from antimicrobial compounds or antiviral compounds; at a coating application station 630. The coating application station 620 may comprise first apparatus configured to print the composition onto the outer surface; second apparatus configured to brush or roll the composition onto the outer surface; third apparatus configured to contact the outer surface of the base article with a reservoir of the composition; or two or more thereof.

In one embodiment, the packaging article processing station 610 may be further configured to apply the composition to at least a portion of the inner surface of the base article.

The packaging article processing system 610 may remove, at a solvent removal station 640, the solvent to yield a coating comprising a compound selected from antimicrobial compounds or antiviral compounds on at least a portion of the outer surface of the base article. The solvent removal station 640 may comprise apparatus to apply heat, reduce pressure (e.g., apply vacuum), reduce humidity (e.g., apply desiccant), apply ultraviolet (UV) light, maintain ambient temperature, maintain humidity, and/or maintain pressure in proximity to the composition on the outer surface; or two or more thereof.

After solvent is removed, to yield packaging article 100, the packaging article 100 may be delivered by the packaging article processing system 610, such as by second conveyor belt 602 or comparable conveyance apparatus, to subsequent processing steps, including, but not necessarily limited to, conforming the packaging article 100 for insert of a good, inserting the good, sealing the good in the packaging article, and entering the packaged good into commerce. Such subsequent steps will be apparent to the person of ordinary skill in the art having the benefit of the present disclosure and need not be described further.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A packaging article, comprising:
a base article having an outer surface and an inner surface; and
a coating on at least a portion of the outer surface of the base article,
wherein the coating comprises:
a compound selected from antimicrobial compounds or antiviral compounds.

2. The packaging article of claim 1, wherein the compound is selected from the group consisting of silver ion compounds; zinc compounds; copper compounds; quaternary ammonium compounds (“quats”); oxazoline homopolymers; oxazoline copolymers; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles; polyhexamethylene biguanide hydrochloride; 3,4,4′-trichlorocarbanilide; isothiazolone-based compounds; alkyl dimethyl ammonium saccharinate; oxathiazines; chlorothalonil; and two or more thereof.

3. The packaging article of claim 1, wherein the base article comprises cardboard, paper, paperboard, metal, viscoelastic foam, flexible plastic, rigid plastic, or two or more thereof.

4. The packaging article of claim 3, wherein the base article is configured to retain a mattress, a mattress topper, or a pillow.

5. The packaging article of claim 1, wherein:
the coating is further on at least a portion of the inner surface of the base article.

6. A method, comprising:
providing a base article having an outer surface and an inner surface;
applying to at least a portion of the outer surface of the base article a composition comprising a solvent; and a compound selected from antimicrobial compounds or antiviral compounds;
removing the solvent to yield a coating comprising a compound selected from antimicrobial compounds or antiviral compounds on at least a portion of the outer surface of the base article.

7. The method of claim 6, wherein the compound is selected from the group consisting of silver ion compounds; zinc compounds; copper compounds; quaternary ammonium compounds (“quats”); oxazoline homopolymers; oxazoline copolymers; zinc pyrithione; sodium pyrithione; photocatalytic titanium dioxide; barium metaborate monohydrate; 2,4,4′-trichloro-2′-hydroxydiphenyl ether; diiodomethyl p-tolylsulfone; azoles; polyhexamethylene biguanide hydrochloride; 3,4,4′-trichlorocarbanilide; isothiazolone-based compounds; alkyl dimethyl ammonium saccharinate; oxathiazines; chlorothalonil; and two or more thereof.

8. The method of claim 6, wherein the base article comprises cardboard, paper, paperboard, metal, viscoelastic foam, flexible plastic, rigid plastic, or two or more thereof.

9. The method of claim 8, wherein the base article is configured to retain a mattress, a mattress topper, or a pillow.

10. The method of claim 6, wherein the applying comprises printing the composition onto the outer surface.

11. The method of claim 6, wherein the applying comprises brushing or rolling the composition onto the outer surface.

12. The method of claim 6, wherein the applying comprises contacting the outer surface of the base article with a reservoir of the composition.

13. The method of claim 6, wherein the removing comprises applying heat, reduced pressure, reduced humidity, ultraviolet (UV) light, or two or more thereof to the composition.

14. The method of claim 6, wherein the removing comprises maintaining ambient temperature, humidity, and pressure in proximity to the composition on the outer surface.

15. The method of claim 6, further comprising:
applying the composition to at least a portion of the inner surface of the base article.

16. A system, comprising:
a processing controller configured to control a packaging article processing system; and
the packaging article processing system, wherein the packaging article processing system is configured to:
provide a base article having an outer surface and an inner surface;
apply to at least a portion of the outer surface of the base article a composition comprising a solvent; and a compound selected from antimicrobial compounds or antiviral compounds;
remove the solvent to yield a coating comprising a compound selected from antimicrobial compounds or antiviral compounds on at least a portion of the outer surface of the base article.

17. The system of claim 16, wherein the packaging article processing system is configured to apply the composition by printing the composition onto the outer surface; brushing or rolling the composition onto the outer surface; contacting the outer surface of the base article with a reservoir of the composition; or two or more thereof.

18. The system of claim 16, wherein the packaging article processing system is configured to remove the solvent by applying heat, reduced pressure, reduced humidity, ultraviolet (UV) light, or two or more thereof to the composition; maintaining ambient temperature, humidity, and pressure in proximity to the composition on the outer surface; or both.

19. The system of claim 16, wherein the packaging article processing system is further configured to:
apply the composition to at least a portion of the inner surface of the base article.
